(19) United States
(12) Patent Application Publication
(10) Pub. No.: US 2002/0000975 A1
(43) Pub. Date: Jan. 3, 2002

(54) Keyboard with interchangeable device

(76) Inventors: Mark H. Perkins, Glendale, AZ (US); Kenneth W. Schilling, Peoria, AZ (US); George Tsai, Glendale, AZ (US)

Correspondence Address: Alexander B. Ching, Esq., Squire, Sanders & Dempsey L. L. P., Two Renaissance Square, 40 North Central Ave., Suite2700, Phoenix, AZ, 85004-2391, US

(21) Appl. No.: 09/765,169

(22) Filed: Jan. 18, 2001

Related U.S. Application Data
(60) Provisional application No. 60/176,616, filed on Jan. 18, 2000.

(51) Int. Cl. G09G 5/00

(52) U.S. Cl. 345/168

(57) ABSTRACT

In one embodiment, a keyboard with an interchangeable device is disclosed. The keyboard comprises a standard, or near standard keyboard for use with a computer. The keyboard includes at least one device that can be inserted into the keyboard. The insertable device can be an input device such as a trackball or touchpad which can be removed and replaced with another input device.

### TECHNICAL FIELD OF THE INVENTION

This invention relates to the field of computer keyboards and more specifically to a keyboard with interchangeable devices.

### BACKGROUND OF THE INVENTION

A computer keyboard is a computer input/output device having a plurality of keys that is utilized by an operator to input text or other symbols into a computer's memory and/or for display on a monitor. A basic computer keyboard generally has keys for inputting alphanumerical characters as well as additional special keys, which perform specific functions. Another popular input device is a computer mouse. Physical manipulation of the computer mouse will translate to movements of a cursor around a screen. Typically these two input devices are provided as separate devices with separate connections to a computer. If the units are integrated, the computer mouse, or similar input item, becomes physically part of the keyboard and cannot be removed.

Thus, standard computer keyboards lack the ability for customization. Therefore, a user may buy a computer with a keyboard that is not suited to the user's taste or needs. What is needed is a computer keyboard with interchangeable devices.

### SUMMARY OF THE INVENTION

In one embodiment, a keyboard with an interchangeable device is disclosed. The keyboard comprises a standard, or near standard keyboard for use with a computer. The keyboard includes at least one device that can be inserted into the keyboard. The insertable device can be an input device such as a trackball or touchpad which can be removed and replaced with another input device.

### BRIEF DESCRIPTION OF THE INVENTION

For a more complete understanding of the present invention and advantages thereof, reference is now made to the following descriptions, taken in conjunction with the following drawings, in which like reference numerals represent like parts, and in which:

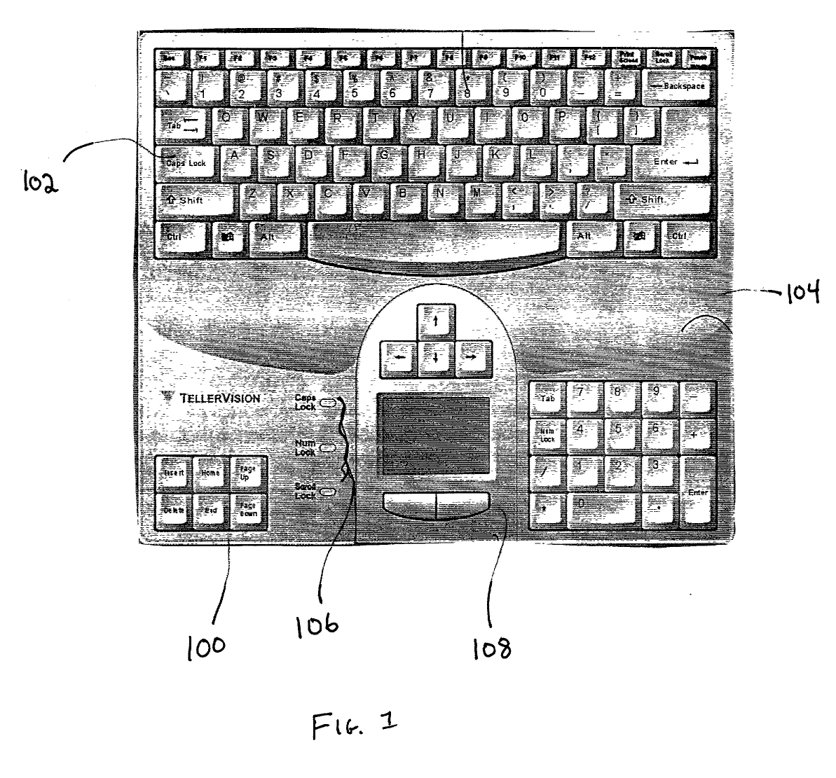

FIG. 1 illustrates a keyboard in accordance with the teachings of the present invention;

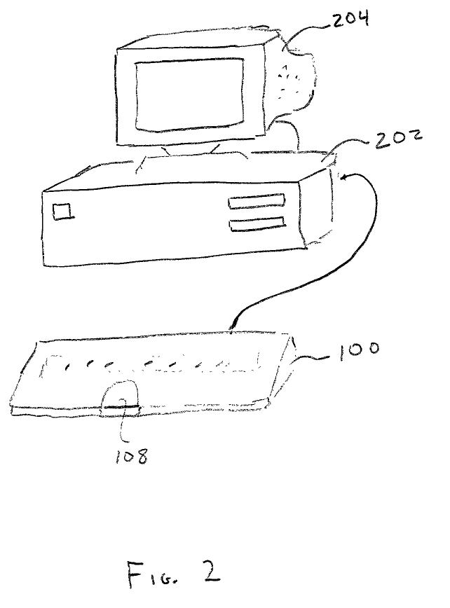

FIG. 2 illustrates the size of the keyboard;

FIG. 3 illustrates exemplary interchangeable modules;

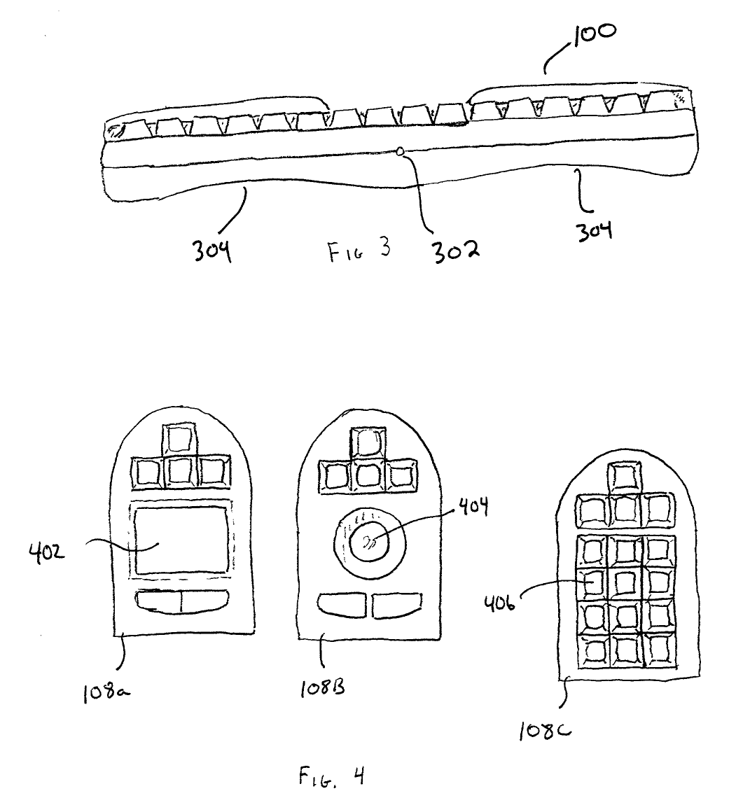

FIG. 4 illustrates an interchangeable module with a connector; and

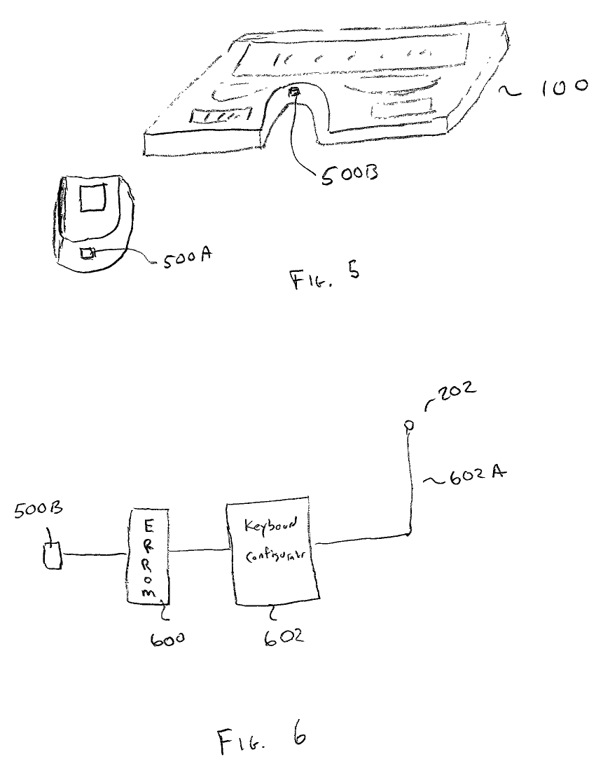

FIG. 5 illustrates a keyboard connector.

### DETAILED DESCRIPTION OF THE INVENTION

FIG. 1 illustrates a keyboard 100 in accordance with the teaching of the present invention. Keyboard 100 includes a plurality of keys 102 for use in inputting information into a computer or similar device. Keys 102 for an English language keyboard are typically arranged in a standard QWERTY arrangement. However, any other standard or non standard configuration can be used, including configuration to support non-English languages. The alignment of the keys may also be altered to allow for ergometric arrangements of the keys 102.

Keyboard 100 may also include a handrest 104 and indicator lights 106. Handrest 104 is designed to allow the hands to rest comfortably while using keyboard 100 and to avoid repetitive stress injury. Indicator lights 106 are used to indicate such information as whether the caps lock key or numerical lock key are in the on or off position.

Keyboard 100 also includes an interchangeable module 108 which can be removed from keyboard 100 and replaced with another module 108. Interchangeable modules 108 are further described in conjunction with FIG. 3. In use, keyboard 100 acts as a standard computer keyboard. As seen in FIG. 2 keyboard 100 is operable to be connected to a computer 202 or similar device which receives external inputs such as a terminal. A user (not pictured) depresses keys 102 on keyboard 100 which sends signals to computer 202 which are then interpreted by the operating system or program currently running on computer 202 and can then be displayed on the monitor 204 or stored internal to computer 202. Interchangeable module 108 is shown in FIG. 1 near the bottom center of keyboard 100. This is for illustration only. Interchangeable module can be located anywhere around the periphery of keyboard 100. In one embodiment, multiple devices can be attached to keyboard 100.

Turning to FIG. 3, keyboard 100 includes a connector port 302. This allows keyboard 100 to be connected to a computer via a standard keyboard connector, such as a PS/2 connector. Of course, it is well-known that a keyboard can be connected to a computer using various other means including a universal serial bus cable, a serial port attachment, a wireless or infra red link, or a radio frequency/radio wave link. Thus, the connection between keyboard 100 and computer 202 can be any wired or wireless connection. Also pictured in FIG. 3 are optional indentations 304, which may be formed on keyboard 100 in order to fit the lap of a user. Keyboard 100 can also be integrated into a laptop or similar computer.

FIG. 4 illustrates interchangeable modules 108, which can be inserted into keyboard 100. First module 108A illustrates a touchpad module, which includes a touch sensitive pad 402 that translates the movement of fingers along the pad to the movement of the cursor around a computer display. Second module 108B illustrates a trackball module that includes a rotating ball 404 that can be used to move a cursor around a computer display. Third module 108C includes keys 406 that can be used to input special characters not readily supported by a standard keyboard, or form shortcuts or macros which consists of a combination of keystrokes that takes the place of lengthy or complex keystrokes. The shortcuts or macros can be either pre-programmed or programmed into the keyboard 100. Other modules 108 can exist with other input means such as including joysticks, other types of pointing devices, or other types of input devices, or ports.

FIG. 5 illustrates a view of interchangeable module 108 showing a connector 500A as well as a view of keyboard 100 showing a connector 500B. When interchangeable module 108 is inserted into keyboard 100, connector 500A connects with connector 500B to integrate the interchangeable module 108 into the keyboard. When interchangeable module 108 is attached to keyboard 100, keyboard 100 will recognize the module that is inserted and the keyboard operation will be configured to correspond to that module. This recognition can be done by the keyboard or by the computer. In one embodiment, the reconfigured keyboard 100 is recognized via the plug and play capabilities of the operating system. In one embodiment, the connection between the module 108 and keyboard 100 is an RS 232 connection although other types of connection would be known to those skilled in the art.

FIG. 6 is a schematic drawing of a connector inside of keyboard 100 showing the connection between the connecting port 500B and an EPROM 600 in accordance with the teaching of the present invention. EPROM 600 is an erasable programmable memory, which can be used to store a program or routine that can be used to detect the type of interchangeable unit attached to connector 500B. Then, a keyboard configurator 602 can be used in conjunction with EPROM 600 to configure the keyboard for use with a particular interchangeable module 108. Once that information is programmed into the keyboard, the information can be outputted to a computer via port 602A. Port 602A is also the port whereby the input signals are sent to computer 202.

What is claimed is:

1. A keyboard comprising:
a first section having a plurality of keys;
a second section removably attached to the first section, the second section enhancing the input capabilities of the first section.

2. The keyboard of claim 1, wherein the second section contains a trackpad input device.

3. The keyboard of claim 1, wherein the second section contains a trackball input device.

4. The keyboard of claim 1, wherein the second section allows for the entering of special characters.

5. The keyboard of claim 1, wherein the keyboard is coupled to a computer.

6. The keyboard of claim 1, wherein the second section is automatically configured by the keyboard.

7. The keyboard of claim 6, wherein the first section contains a memory and configuration hardware to automatically configure the keyboard.

8. The keyboard of claim 5, wherein the keyboard is wirelessly attached to the computer.

9. A module for a keyboard comprising:
at least one input means mounted on the module; and
a module connector attached to one end of the module for connecting with a keyboard connector mounted on the keyboard.

10. The module of claim 9, wherein the input means includes a trackpad input device.

11. The module of claim 9, wherein the input means includes a trackball input device.

12. The module of claim 9, wherein the input means includes keys that allows for the entering of special characters.

13. The module of claim 9, wherein the module is automatically recognized by the keyboard when inserted into the keyboard.

14. A computer system comprising:
a central processing unit;
a monitor coupled to the central processing unit for displaying alphanumerical characters generated by the central processing unit; and
a keyboard, coupled to the central processing unit comprising:
a main section having a plurality of keys;
a module section removeably attached to the main section, the module section enhancing the input capabilities of the main section.

15. The computer of claim 14, wherein the module section contains a trackpad input device.

16. The computer of claim 14, wherein the module section contains a trackball input device.

17. The computer of claim 14, wherein the module section allows for the entering of special characters.

18. The computer of claim 14, wherein the module section is automatically configured by the keyboard.

19. The computer of claim 18, wherein the first section contains a memory and configuration hardware to automatically configure the keyboard.

20. The computer of claim 14, wherein the keyboard is wirelessly attached to the computer.
